(19) United States
(12) Patent Application Publication
(10) Pub. No.: US 2024/0012956 A1
(43) Pub. Date: Jan. 11, 2024

(54) COMPUTER-SUPPORTED METHOD AND DEVICE FOR GENERATING A DIGITAL REPRESENTATION OF A TECHNICAL STRUCTURE, AND CORRESPONDING COMPUTER PROGRAM PRODUCT

(71) Applicant: Siemens Aktiengesellschaft, 80333 München (DE)

(72) Inventors: Philipp Rauh, Nürnberg (DE); CHRISTIAN BAUER, Gnotzheim (DE)

(73) Assignee: Siemens Aktiengesellschaft, 80333 München (DE)

(21) Appl. No.: 17/769,247

(22) PCT Filed: Sep. 11, 2020
(86) PCT No.: PCT/EP2020/075433

§ 371 Date: Apr. 14, 2022

(30) Foreign Application Priority Data
Oct. 15, 2019 (EP) 19203264.7

(51) Int. Cl. G06F 30/17; G06F 30/23

(52) U.S. Cl. CPC G06F 30/17; G06F 30/23; G06F 2111/10

(57) ABSTRACT

A computer-supported method and a device for generating a digital representation of a technical structure, in particular of an electric motor, and a corresponding computer program product are disclosed. In the method, domain-specific models based on digital geometric data of components are provided, and on the basis thereof a model order reduction is carded out. The domain-specific models are hereby converted into modal coordinates which are used to determine a spectral behavior of the components using a respective modal analysis. Therefrom, corresponding state-space representations are generated as order-reduced spectral models. In order to simulate the technical structure as a whole, the spectral models are coupled together to form the digital representation, which describes the behavior of the technical structure across domains, in order to produce a simulation.

The invention relates to a computer-aided method and a device for generating a digital representation of a technical structure and a corresponding computer program product.

Computer-aided methods are already widely used in modem product development, such as, for example, accurate component modeling based on finite elements and further methods covered by the term CAE (computer-aided engineering). Analyses based on this can provide precise insights into the properties of the respective modeled component and thus accelerate development. However, one disadvantage is that corresponding data is often not generally accessible and comprehensible and is, for example, reserved for FE specialists (FE: finite element). In addition, the computational hardware practicably available today and for the foreseeable future is not able to model and simulate complex systems completely in an acceptable time as this entails too much computational effort and complexity.

Accordingly, to date, approaches have often been limited to separate modeling of individual components and/or to replacing complex systems or structures by radically simplified representations, which are only able to provide very roughly approximated rudimentary Information and results. For example, for an electric motor, the inherently complex structural dynamics of a motor housing can be reduced to two masses and two springs as a simplified starting model for rotor dynamics or the vibration behavior of a rotor can be roughly approximated as a simplified basis for an electrical computation in that only the rotor mass moment of inertia is taken Into account.

Therefore, none of the approaches used to date enable detailed and reliable information and Insights relating to complex structures or systems consisting of several components that are mutually interacting or in contact with one another to be obtained in a practicable way with computer-aided engineering. However, this is precisely what would be of Interest in the future for further improved and digitized product development.

It Is the object of the present invention to disclose an improved possibility for digitally handling a technical structure. This object is achieved according to the invention by the subject matter of the independent claims. Advantageous embodiments and developments of the present Invention are disclosed in the dependent claims, in the description and in the figures.

A method according to the invention is used to generate a digital representation, i.e. a digital model or digital twin, of a prespecified technical structure. A technical structure in the sense of the present invention can, for example, be a unit, a machine, an apparatus, a system, an installation or the like, in particular one that is composed of a plurality of components or structural parts. An example of such a technical structure can, for example, be a high-voltage electric motor (HV motor). Finally, however, the method according to the invention can be used successfully for almost any structures that can be represented or modeled digitally, i.e. in a computer-aided manner.

In one method step of the method according to the invention, domain-specific models of prespecified components of the technical structure based on digital 3D geometry data of these components are provided or acquired. The 3D geometry data Indicates an assembly or a structure of the respective component. Cartesian coordinates in particular, but also cylindrical coordinates, spherical coordinates or the like can be used for this purpose. These coordinates in which the 3D geometry data or the domain-specific models are provided or present are referred to here as original coordinates. In other words, therefore, the geometry of the respective component can be described by the 3D geometry data in the original, in particular Cartesian, coordinates. The 3D geometry data can, for example, be provided in the form of a CAD dataset (CAD: computer-aided design), as an FE model or the like. In the example of an electric motor, which does not limit the present invention thereto, the components can, for example, be the housing, rotor, stator, cooling facility, active electric part and the like thereof.

Here, domain-specific models are models which at least each primarily model or describe properties or behavior of the respective component in a physical-technical domain in each case. Such domains can, for example, be (conventional) mechanics, electrics or electrodynamics, thermal properties or thermodynamics and the like, i.e. In each case they relate to or comprise a subarea or specialist field of physics or technology. Corresponding domain-specific models can be much less complex than a complete model that attempts to model or describe the respective component completely in all domains or aspects. Thus, domain-specific models can advantageously be generated and handled with correspondingly less effort.

The provision or acquisition of the domain-specific models can, for example, mean or comprise their computer-aided or semi-automated generation and/or loading or retrieving them from a data store that is provided or from a library of corresponding models of components.

In a further method step of the method according to the Invention, model order reduction is performed on the basis of the domain-specific models. This reduces the order or complexity, and hence the computational effort, required to go over or digitally handle the models. For this purpose, the domain-specific models are at least partially converted or transformed from their original, in particular Cartesian, coordinates into modal coordinates. Here, these modal coordinates are a set of minimum coordinates, thus advantageously enabling particularly efficient and low-effort computation or simulation.

These modal coordinates are used to determine the spectral behavior of the components by means of a respective modal analysis. In other words, therefore, modal analysis provides here a numerical characterization of the dynamics of the components, wherein these are regarded as systems capable of vibration and/or a decay time or time constant is assigned to the components as a basis for the modal analysis. The dynamics or the spectral behavior of the components can, for example, be characterized or described by modal parameters, eigenfrequencies, eigenshapes or eigenvibration modes, a modal mass, possibly modal damping and/or the like determined within the context of the respective modal analysis.

Based on this, state space representations (SSRs) are then generated for the components as order-reduced spectral models of the components. In other words, the components or their behavior or properties are described or characterized by the spectral models in the respective state space representation. Compared to the original domain-specific models or corresponding FE models of the individual components, here, the model order reduction can result from the fact that only modes, i.e. respective vibration states, of the components as a whole and no longer individual movements or behavior of all parts or regions of the respective component are computed or modeled for all three Cartesian spatial directions. Therefore, spectral models can describe the dynamics or the vibration behavior of the components in a simpler or more compact way than domain-specific models or complete FE models of the components.

In a further method step of the method according to the invention, for a simulation of the technical structure as a whole, the spectral models of the components are coupled or connected to one another to form the digital representation, which describes the behavior of the technical structure across domains. In other words, therefore, similarly to the assembly of a corresponding real technical structure from individual structural parts, the digital representation of the technical structure can be generated by coupling the spectral models for the individual components. Since the spectral models are based on domain-specific models, which can in particular describe the components in different domains, this results in a characterization, description or modeling of the entire technical structure in correspondingly different domains. In this case, a component can be described by a spectral model in each case or properties or behavior of a component in different domains can be described by a plurality of spectral models for this component.

In this case, coupling the individual spectral models to one another advantageously enables interactions between the components, in particular across different domains, to be modeled or simulated and accordingly insights into the behavior or properties of the entire technical structure to be obtained that are not evident from the domain-specific or FE models of the individual components that to date have typically been considered individually. As a result of model order reduction, the computational effort for such modeling and simulation of the entire technical structure advantageously remains practicable even with the computational hardware that is widely available today. In addition, the method according to the invention offers further possibilities for accelerating and reducing the computational effort required, as will be explained in more detail below. Nevertheless, the present invention is still able to provide much more detailed, accurate and reliable results and insights into the behavior of the entire technical structure with the reduced computational effort required than has been possible to obtain to date by the very rough approximation of the components described in the introduction by a few fundamental idealized elements. Thus, the present invention enables, for example, purely digital and computer-aided identification of potential problems or weak points in the design of the technical structure with improved accuracy and reliability during the course of the development or design process and improved adaptation of the components to the real loads that occur. Thus, it is ultimately, for example, possible to improve the reliability of real technical structures while possibly saving material at the same time.

The method according to the invention can be performed by means of a correspondingly configured data processing facility, for example the device according to the invention for data processing, in particular automatically or semi-automatically. The data-processing facility used can, for example, be a conventional computer, a conventional workstation, a mainframe computer or the like. Therefore, the data-processing facility can in particular be a processor, a microchip, an integrated circuit, a hardware circuit or the like for executing a computer program or program code that encodes or represents the method. Furthermore, the data-processing facility can in particular have a volatile and/or non-volatile data memory connected thereto, one or more interfaces for receiving and outputting data and/or the like.

The data-processing facility can have one or more sub-facilities for executing the individual method steps of the method according to the invention. These can, for example, be an acquisition facility or providing facility for acquiring or providing the domain-specific models, a model order reduction facility for performing model order reduction and the processes described in connection therewith, and a coupling facility for generating the digital representation of the technical structure by coupling the spectral models to one another. Likewise, a simulation facility for simulating the technical structure based on the digital representation generated in this way can be provided. These sub-facilities can be or comprise corresponding hardware circuits or hardware modules but also corresponding program parts or program modules of said computer program, i.e. for example an operating program for the data-processing facility.

In an advantageous embodiment of the present invention, a modally decoupled mass matrix M and stiffness matrix K for each of the components is determined in the respective modal analysis. Generally, it is likewise possible for a respective damping matrix D to be determined here. Starting from the equation of motion for the respective components, a new arrangement then takes place via state space representation, i.e. in the formalism of the state space representation. In this case, the differential equation of motion—equation of motion for short—for a component with one degree of freedom can be represented as

\tilde{M}·\ddot{s}+\tilde{D}·ś+\tilde{K}·s=F

wherein s is the position vector and F is an external force. For the special case of modal analysis, F=0 can apply or be set. The corresponding state space representation can be given as

$$\frac{d}{dt} x = A \cdot x + B \cdot u and y = C \cdot x + D \cdot u$$

wherein t is the time, x is the location vector, u is the input vector, y is the output vector, A is the system matrix, B is the input matrix, C is the output matrix and D is the transition matrix. In this case, the matrices of the state space representation are given in the normal form of representation as

$$A = [ \begin{matrix}0 & I \\ - {\tilde{M}}^{- 1} \cdot \tilde{K} & - {\tilde{M}}^{- 1} \cdot \tilde{D}\end{matrix} ] , B = [ \begin{matrix}0 \\ {ϕ}^{T}\end{matrix} ] and C = [ ϕ 0 ] .$$

Here, the transition matrix D can be the zero matrix, i.e. it can be omitted if the technical structure or the respective component is a mechanical system since mechanical systems are not able to jump in terms of location and speed. In many technical structures or for many components of technical structures, for example structural parts of an electric motor, it is possible to assume that damping is negligibly weak so that it is also possible to omit the damping matrix D from the equation of motion. Combining and rearranging the variables then results in the special case of negligible damping:

$$\dot{q} = [ \begin{matrix}0 & I \\ - {\tilde{M}}^{- 1} \cdot \tilde{K} & 0\end{matrix} ] \cdot q + [ \begin{matrix}0 \\ {ϕ}^{T}\end{matrix} ] \cdot u = A \cdot q + B \cdot u and \\ y = [ ϕ 0 ] \cdot q = C \cdot q$$

with the state vector q and the eigenshape matrix ϕ. Therefore, here the modal analysis can be performed as an undamped modal analysis, which advantageously results in simplified computation and correspondingly less effort.

With the approach presented here, the method according to the invention, i.e. digitization and modeling or simulation of technical structures can be implemented particularly effectively and with a practicably manageable computational effort.

In a further advantageous embodiment of the present Invention, the respective modal analysis is only performed for a prespecified lower frequency range and/or only for a prespecifled number of the highest-energy modes. For example, the modal analysis can be restricted to a frequency range between 0 Hz and 2 kHz or between 0 Hz and 1 kHz or between 0 Hz and 500 Hz. Additionally or alternatively, the modal analysis can be limited to relatively high-energy modes. For this purpose, the modes can, for example, be sorted according to their energy content or their contribution to the total energy of the vibration or dynamics of the respective component. Of these, then only the n modes with the highest energy can be considered or used for further computations, wherein n can be a prespecified number or a prespecified, for example percentual, proportion. Likewise, a type, a basic structure or prespecified reference or comparative values can, for example, be used as the basis for making or prespecifying an assumption or estimation as to which frequency ranges are likely to contain the highest-energy modes for the respective component and the modal analysis can then be limited thereto. The limitation of the modal analysis proposed here enables the required computational effort to be further reduced. However, experience has shown that the specific limitation proposed here can still provide particularly relevant information and Insights relating to the behavior and properties of the components and the technical structure as a whole.

In a further advantageous embodiment of the present Invention, for model order reduction, conversion of the Cartesian coordinates into modal coordinates and/or back-conversion from modal coordinates into Cartesian coordinates after modal analysis Is only performed for a prespecified selection of discrete observation points at which an external effect of the technical structure as a whole is determined during the simulation. Depending upon the complexity of the technical structure, for example, a maximum of 1000 or a maximum of 100 observation points can be prespecified or used. These observation points can, in particular, be nodal points, connecting or attaching points of the components, bearing or supporting points or the like. It has been shown that such a limitation to specific observation points, which are essential for the behavior of the technical structure and the properties thereof, enables data typically required or demanded nowadays, for example for adapting the components and/or for loading further structural parts in the environment of or in contact with the technical structure, to be obtained. In this case, it is possible to reduce the computational effort or the amount of data to be handled by several orders of magnitude compared to complete, for example FE-based, modeling and simulation of the technical structure. In this case, however, the structure of the modeling method according to the invention proposed here enables the accuracy of the results for the behavior of the technical structure at the observation points to still be in the range of accuracy that can also be achieved with a complete FE analysis, for example with deviations of maximum 5% or maximum 10%. Therefore, limitation to the prespecified observation points can provide a particularly effective and efficient contribution to model order reduction.

At the prespecified observation points, there can here ultimately be a bidirectional connection between the inner, i.e. model-internal, modal description and the outer Cartesian description of the components or the technical structure. In this case, this connection is generated by means of or based on the respective eigenshapes. Likewise, like the respective eigenfrequencies, these are part of the modal analysis and are thus anyway available and do not generate any further or additional computational effort. Hence, it is not only possible to reduce the amount of data to be handled in the present method according to the invention; it is also, for example, possible to reduce data derived therefrom or obtained on the basis thereof and made available to other applications or programs accordingly. The embodiment of the present invention proposed here is based on the knowledge that many steps, for example in the development, production, installation, evaluation and Inspection of technical structures, require only a limited amount of core information, but not complete global knowledge of the detailed behavior of the respective technical structure at all points or in all areas. For example, in the case of an electric motor, its behavior at an Interface to a load machine, at a power terminal and at support points or a foundation can be of particular importance. Even for complex technical structures that are made up of a plurality of components coupled to one another, the method according to the invention makes it possible to obtain detailed and reliable information on the behavior at these or corresponding observation points with improved accuracy or practicably manageable effort compared to previous approaches.

In an advantageous development of the present invention, the observation points in the 3D geometry data or a corresponding FE model of the components are automatically established in dependence on the category of the respective component. The categories can be prespecified, for example in a table or database or as parameters or in metadata for the respective geometry data, the respective FE model or the respective component. The categories can indicate a sort or type of the components. For example, a component can be or will be categorized as a housing, heat sink, bearing, axle or shaft, rotor, active electric part, foundation and/or the like. For example, the points or points to be used as observation points can be prespecified for each category. As described, this can be, for example, bearing or support points, nodal points, connecting or attaching points and likewise extreme points, such as, for example, a point or area of minimum diameter or minimum material thickness, a lowest point, an uppermost point or a middle point or focal point or the like. These types of observation points can then be automatically determined for the respective component in the geometry data or in the FE model. This enables even more extensive automation of the method according to the invention to be achieved and thus further minimization of the effort required to obtain useful results or insights.

Likewise, some or all of the observation points can be manually prespecified or established or adapted. In any case, as soon as the observation points are established, automatically or manually, further measures or steps can be automated based thereupon. Thus, it is then, for example, possible, also depending on the category of the respective component and/or the number and/or type of observation points established, automatically, for example, to establish or select a sampling rate or frequency for the modal analysis or the simulation, a number of eigenshapes or modes to be determined, a frequency range to be observed or analyzed, a coordinate system to be used, a number and type of degrees of freedom to be taken into account and/or the like. Corresponding regulations and/or assignment tables can be prespecified for this.

In a further advantageous embodiment of the present invention, when generating the digital representation of the technical structure, idealized coupling elements are used for connecting at least some of the spectral models of the components to one another and/or to further prespecified elements. Such idealized coupling elements can, for example, be ideal springs, dampers, masses or mass oscillators or the like. Such Idealized coupling elements can each represent or model a specific basic property in a mathematically or mechanically idealized manner, i.e. abstracted from real structural parts. Thus, the idealized coupling elements and, accordingly, also the connections of the components or the further elements are particularly easy to model and compute. Since, however, the components that are interconnected in this way are themselves modeled with greater accuracy, the loads occurring at the end or connecting points of the idealized coupling elements can correspondingly accurately reflect the behavior of a corresponding real technical structure so that, despite the use of the idealized coupling elements, the accuracy is ultimately sufficient for practical purposes.

The further elements mentioned can, for example, represent bearing stiffness, friction effects, in particular air friction of moving components, and/or the like. Therefore, the further elements can in particular represent effects or influences that cannot easily be modeled or represented in the form of 3D geometry data or as independent FE models. In particular, the further elements can model or simulate nonlinearities that can be present via the simulation level of the corresponding more comprehensive system consisting of components and further elements. For example, such nonlinearities can be present in a journal bearing, in the air gap of the HV motor and/or at further locations. The further elements can likewise be idealized or abstracted or prespecified by Individual models, for example based on causal or physical modeling.

In a further advantageous embodiment of the present invention, at least one of the spectral models of the components is also connected to at least one prespecified digitized ambient component representing an environment of the technical structure in a planned real application. This generates a digital representation of an installation comprising the technical structure for the simulation. Therefore, the ambient component can, for example, in turn be or represent a technical structure that, together with the original technical structure, forms the installation or is part of the installation. Examples of such an ambient component can be or represent a foundation on which the technical structure is to be supported, a power terminal or a power supply device via which the technical structure is to be supplied with power or energy, a load machine operated or driven by means of the technical structure, a holder for the technical structure, a machine hall in which the technical structure is to be arranged and/or the like. Therefore, the ambient component can represent or depict a respective real operational and/or working environment for the technical structure. This is particularly advantageous since the behavior of the technical structure can be influenced by its environment and/or insights can be obtained in this way according to which the adaptation or embodiment of the environment can be optimized. Hence, taking account of the respective environment therefore advantageously enables individual adaptations or evaluations for different application scenarios of the technical structure. To date, this has not been practicably possible since, on the one hand, a complete FE analysis would require an unmanageable effort for this and, on the other, the greatly simplified representation of the technical structure mentioned in the introduction does not provide or enable sufficiently accurate data and information with just a few Idealized elements.

In an advantageous development of the present invention, the at least one ambient component is initially represented by at least one Idealized element. This Is then replaced in an iterative improvement process of the digital representation of the installation by a finite element model (FE model) or an order-reduced spectral model of the ambient component derived therefrom. In other words, therefore, the digital representation of the installation can be gradually adapted and improved or made more detailed, for example as soon as correspondingly detailed models for the at least one ambient component become available in a corresponding development or design process. Here, a particular advantage of the present invention Is that this is easily possible due to the modular structure of the digital representation. Due to the fact that the ambient component Is initially represented by an Idealized element, the initial computational effort can be minimized so that first Insights can be obtained particularly quickly and at an early stage. Hence, it is possible to improve the efficiency and parallelism of the development and design process for the technical structure or the installation. Here, an idealized element means a description based on idealized assumptions that ignores complex effects that occur in reality, as is, for example, known from the simplest models and theories of conventional mechanics, electrodynamics and thermodynamics.

A further aspect of the present invention Is a computer program product comprising commands or control instructions which, when executed by a computer, in particular the device for data processing according to the invention or the data-processing facility mentioned in connection with the method according to the invention, cause this computer to execute at least one variant of the method according to the invention, in particular automatically or semi-automatically. The computer program product according to the invention can be a computer program. Therefore, the method according to the invention can accordingly be wholly or partially computer-implemented or computer-implementable, i.e. coded or represented by such a computer program or a corresponding program code. Likewise, the computer program product according to the invention can be a computer-readable data carrier on which a corresponding computer program is stored.

A further aspect of the present invention is the aforementioned device for data processing. This device has means for executing, in particular automatically or semi-automatically, at least one variant of the method according to the Invention. These means can in particular be the means described in connection with the aforementioned data-processing facility. Therefore, the device according to the invention can in particular have a corresponding processor, a data memory and at least one input and/or output Interface for executing the method or the corresponding computer program or program code. In particular, the device according to the Invention can comprise the computer program product according to the invention. Since, therefore, the device according to the Invention can in particular be configured to execute the method according to the Invention and the method according to the invention can, therefore, be executed by means of the device according to the invention, the device according to the Invention can correspondingly have some or all of the properties and/or features described in connection with the method according to the invention.

The invention also includes developments of the various aspects of the invention, i.e. the method according to the Invention, the computer program product according to the invention and the device according to the invention, which have features that are only described in connection with one or some of these aspects of the invention. In order to avoid unnecessary redundancy, the corresponding developments of the present invention or individual aspects thereof are not described again separately here for all of these aspects.

The invention also comprises combinations of the features of the described embodiments.

The following describes exemplary embodiments of this invention. For this purpose, the figures show:

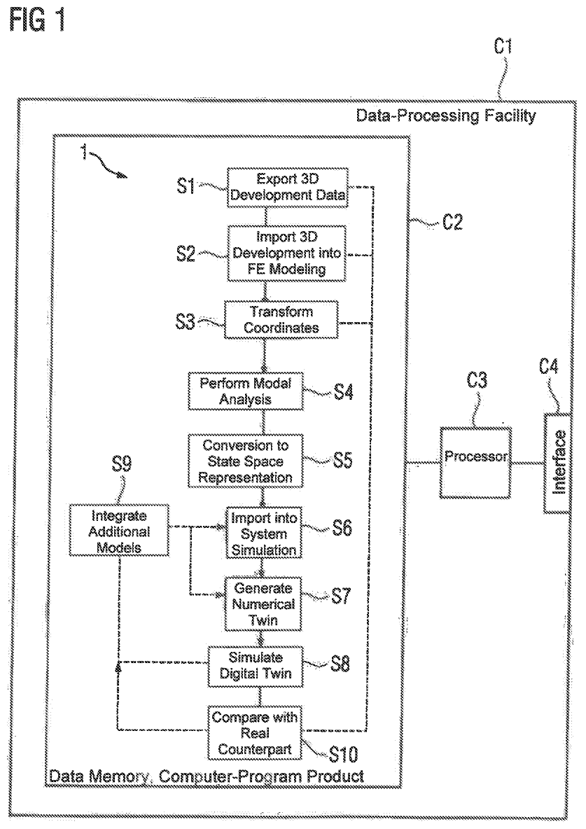

FIG. 1 a schematic representation of a device for executing a method for providing a digital representation of a technical structure, wherein the method is represented by an exemplary flowchart;

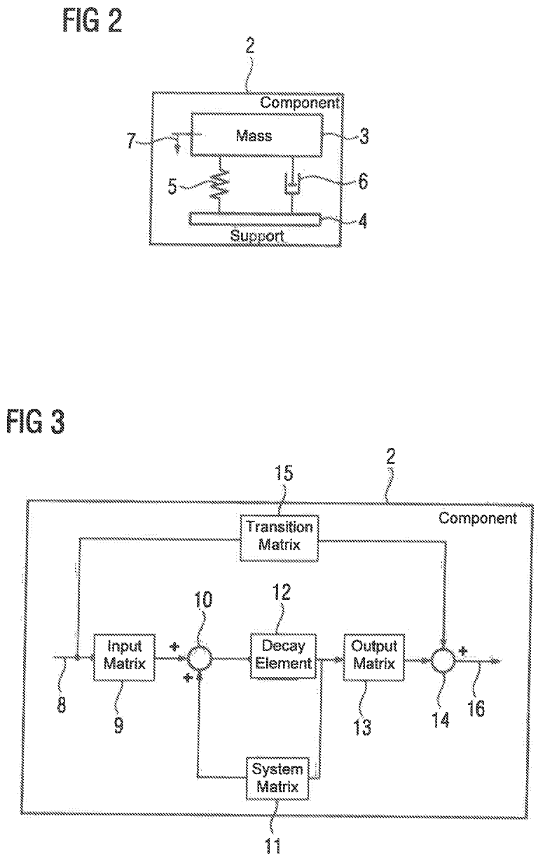

FIG. 2 a schematic representation illustrating a first description of a component;

FIG. 3 a schematic representation illustrating a second description of the component; and

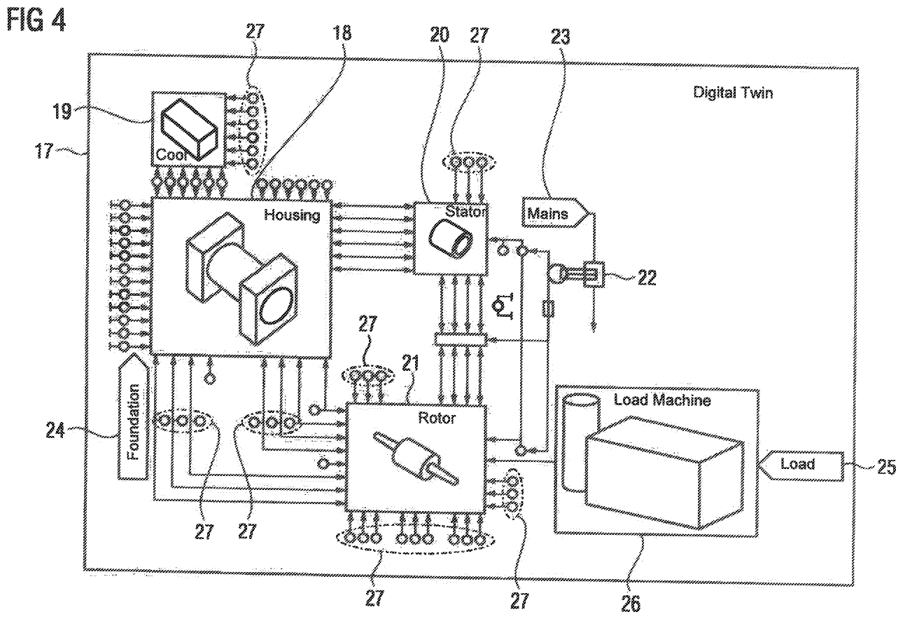

FIG. 4 a schematic representation illustrating the digital representation.

The exemplary embodiments explained below are preferred embodiments of the invention. In the exemplary embodiments, the components of the embodiments described in each case represent Individual features of the invention that should be considered independently of one another and each of which also develop the invention independently of one another. Therefore, the disclosure is also intended to comprise combinations of the features of the embodiments other than those shown. Furthermore, the embodiments described can also be supplemented by further features of the invention that have already been described.

For various reasons, it is desirable and advantageous to have a digital image or a digital representation of a technical structure, for example to support product development and Inspection. The following is based, purely by way of example, on a high-voltage electric motor (HV motor), which consists of a plurality of components and structural parts and hence represents a complex technical structure. For adaptation on the part of research and development, there have only been two alteratives available for digital, i.e. computer-aided, consideration of such a complex technical structure, In which a plurality of components, each primarily acting in different physical technical domains, are coupled to one another. These are, first, complex multi-physics simulation and, secondly, omission of coupled consideration of the entire technical structure. The former is not practicable at present due to the resources required so that correct simulation of the entire system is usually dispensed with in practice, The same applies likewise to preventive analysis, for example of an entire drive chain.

It should also be noted that complex technical structures can typically be provided in different configurations depending on requirements or customer wishes. This means that, even if analysis or simulation is performed for extreme values, for example the heaviest, lightest, longest, shortest etc. configuration or variant, this often does not enable reliable information or optimized adaptation for customer-specific variants or configurations that lie in the middle of a corresponding parameter field and may have unrecognized unfavorable combinations or interactions between individual components.

Instead of a complete, i.e. physically at least substantially correct consideration of the overall system, i.e. the entire technical structure, a simulation and corresponding adaptation can currently be performed separately and domain-specifically for the individual components of the respective technical structure. Thus, simulation or computer-supported investigation or analysis is in each case limited to individual components and individual domains and the adaptation of the individual components, and thus the technical structure as a whole, is also only performed in the individual domains without an overall systemic representation. In addition, with the processes established today, even the corresponding simulation data for the individual components is often only available to specialists, for example within a specialized program for finite-element modeling (FE modeling), and thus is not available to other departments (for example Engineering or Sales) or respective customers or users or final consumers. However, as can be seen from requests for a digitized image for the transient simulation of complete technical structures, there is a corresponding need.

In addition, instead of providing corresponding accurate simulation data or models, to date, these have typically been reduced to very rough Information. For example, the complex structural dynamics of a motor housing were reduced to two masses and two springs in order, for example, to enable combination with rotor dynamics. For electrical computation, for example, the vibration behavior of a rotor was very roughly approximated in that only the mass moment of Inertia of the rotor was considered. Herein, in addition, the individual components are not completely simulated, but, for example, represented by equivalent circuit diagrams or simple basic geometric shapes or abstract mass points.

In order to solve these difficulties, problems and inadequacies, a modeling method is presented here by means of which items of core information can be extracted from detailed analyses of the individual domains and combined with one another across domains to enable a joint overall systemic consideration with improved accuracy. This advantageously makes it possible to simulate a specific variant or configuration of the respective technical structure across domains. In this case, the respective specific variant or configuration is digitally assembled from Individual domain-specific models of the components or main components of the respective technical structure.

In this case, it is advantageously also possible to take into account knowledge of the environment of the respective technical structure in order ultimately to simulate the behavior of the respective specific configuration of the technical structure in a specifically intended operational or working environment.

The individual components are modeled domain-specifically, in particular based on the respective digital 3D geometry data provided. In this case, if necessary, a plurality of domain-specific models of different domains can be generated or provided for a single component, but, in this case, each of these can be based on the same 3D geometry of the component. In this case, design-based or specification-based dimensions for the geometries or corresponding 3D geometry data can be used in each case, so that here the components are not simplified or abstracted with regard to their geometry or with regard to their structure; this ultimately enables Improved accuracy of the results obtained to be achieved. Ambient components or ambient elements, i.e. elements of the environment or representing the environment, can be provided or represented in the same way or, if necessary, by simplified or idealized elements.

The technology presented here enables the relevant spectral behavior of the respective technical structure to be extracted from the individual domains so that the previous hardly manageable computation models for a complete simulation, which can, for example, comprise 10 million equations solely for the structural dynamics of the motor housing, can effectively be bundled into comparatively few, for example 10 to 100 or up to 1000 equations. The type of extraction and processing can advantageously even enable corresponding data or models to be forwarded to third parties, for example to external companies or customers, without disclosing knowledge relevant to development or production, i.e. in compliance with confidentiality requirements. Thus, third parties can receive a digital image of the respective technical structure in the specific configuration requested for transient computations of relevant parameters, from which, however, no explicit detailed information about the internal workings or internal structure of the technical structure can be Inferred.

In this regard, FIG. 1 shows a schematic representation of a data-processing facility C1, for example a computer, for executing a method for providing a digital representation of a technical structure. Here, the data-processing facility C1 has a data memory C2, a processor C3 connected thereto and an Interface C4 connected thereto for receiving and outputting data. Here, a computer program, which implements the method, is stored on the data memory C2. Here, corresponding program modules or method sequences are represented by a flowchart 1 with method steps S1 to S10. The following explains the method in more detail based on the flowchart 1 with reference to the other figures.

The method is primarily used to generate a numerical twin of the respective technical structure, i.e. here the HV motor, and provides a corresponding workflow. In method step S1, here, the digital 3D geometry data for the individual components of the HV motor is first exported from a development environment, here a PLM system (PLM: Product Lifecycle Management). In this case, a neutral, i.e. manufacturer-independent, standardized file format that is not tied to a specific application is used, for example STEP (Standard for the Exchange of Product Model Data). In this case, STEP advantageously enables particularly small amounts of data and, as experience has shown, can supply particularly good conversion results.

In method step S2, the geometry data exported in this way, i.e. a corresponding dataset, for example of 3D CAD data, is Imported into a program for FE modeling or FE simulation, for example “Ansys Mechanical”. This processes the dataset in a CAE-compatible manner (CAE: computer-aided engineering). For this purpose, for example, elements, which are not part of the basic structure of the respective component and thus are of no relevance or of little relevance for the behavior of the respective component, can be removed in order to reduce an amount of data. These can, for example, be elements of the actual component, such as, for example, holes for attaching further elements, lubricant channels, cable holders, etc. or further elements fastened to the actual component contained in the Imported dataset. This CAE-compatible preparation can be seen as a first part of the model order reduction by which the amount of data to be handled and a corresponding computational effort or simulation effort is reduced or limited here to such an extent that the method described here can be performed with conventionally available computational hardware, for example conventional workstation computers or workstations and no mainframes or supercomputers have to be used.

In the FE program, the geometries of the components are described in original coordinates. These can typically be Cartesian coordinates, so that there are therefore then three sets of equation systems for the height, depth and width of the respective component.

In method step S3, a correspondingly obtained analysis basis, ultimately therefore, the geometry or the FE dataset or the FE model, is transformed from the original, in particular Cartesian, coordinates into minimal modal coordinates. This can preferably be performed for only a prespecified discrete set of points, which forms a relatively small part of all points of the FE model. This represents a further part of the model order reduction by which the subsequent computations or simulations are simplified.

In method step S4, a respective modal analysis is performed for the individual components, i.e. based on the domain-specific models, in order to determine the respective spectral behavior of the components. In this case, the modal analysis is limited to the prespecified set of points, i.e. prespecified observation points 27 (see FIG. 4) at which the behavior of the respective component is particularly relevant in practice. These observation points can, for example, be nodal points, connecting points or attaching points to the environment or to further components, bearing points, extreme points of the components, middle points or points that are characterized in some other way. In addition, preferably only relatively low-frequency, but relatively high-energy, modes, for example up to a frequency of 500 Hz, can be taken into account. These limitations to essential data at essential points can, for example, enable the amount of data to be processed to be reduced by about five orders of magnitude, that is by about 99.999%. However, results ultimately obtained thereby in the selected observation points 27 can still be approximately within the accuracy of a complete FE analysis. The described limitation of the modal analysis represents a significant part of the model order reduction.

In the present case, an undamped modal analysis is performed which contains or uses a respective differential equation of motion in basic form for the components. In the modal analysis, a respective modally decoupled mass matrix M and stiffness matrix K are computed for the components. In method step S5, these are converted into a state space representation (SSR) and rearranged. This can be represented in simplified form for one degree of freedom as:

$$\tilde{M} \cdot \ddot{x} + \tilde{K} \cdot x = F \to \frac{d}{dt} q = A \cdot q + B \cdot u and y = C \cdot q with \\ A = [ \begin{matrix}0 & I \\ - {\tilde{M}}^{- 1} \cdot \tilde{K} & 0\end{matrix} ] , B = [ \begin{matrix}0 \\ {ϕ}^{T}\end{matrix} ] and C = [ ϕ 0 ]$$

with the location vector x, an external force F, the time variable t, the state vector q, the system matrix A, the input matrix B, the output matrix C, the output vector y, the diagonal matrix \tilde{M}−19 \tilde{K}=diag(ω²) of the eigenfrequencies w and the eigenshape matrix ϕ.

Here, a transition matrix that is otherwise sometimes used in state space representations can be the zero matrix and thus be omitted since mechanical systems are not able to jump in terms of location and speed and the technical structures considered here can always also be mechanical systems. Likewise, here it is assumed by way of example that damping is negligibly weak so that the damping matrix that would otherwise occur here is also 0.

FIG. 2 shows a schematic representation illustrating a first description of a component 2 corresponding to the differential equation of motion. Here, the component 2 is represented schematically by a mass 3 and a support 4 and the coupling thereof by means of a spring 5 and a damper. The behavior of the component 2 is characterized by a position vector 7, also represented schematically here, corresponding to the variable x. In the present case, a damping matrix may be omitted from the differential equation of motion for the component 2, since, for example, structural components of the HV motor are anyway only weakly damped. This also enables the circumvention of FE solver limitations due to which a damped modal analysis is currently not feasible.

FIG. 3 shows a schematic representation illustrating a second description of the component 2 corresponding to the normal form of the state space representation. Here, a time-dependent input vector 8, corresponding to the variable u, is combined with an input matrix 9, corresponding to the variable B. The result obtained is added to a system matrix 11, corresponding to the variable A, in a first combination element 10. The result obtained is combined with a decay element 12 that introduces a time constant or a proportionality to 1/second, i.e. a frequency. The result obtained is combined with an output matrix 13, corresponding to the variable C. A corresponding result is additively combined with the transition matrix 15, corresponding to the variable D, in a second combination element 14, provided this matrix is not omitted. Finally, the result is a time-dependent output vector 16, corresponding to the variable y.

Thus, disregarding damping, combining the differential equation of motion and the SSR, corresponding to a combination of the descriptions according to FIG. 2 and FIG. 3, and the rearrangement of the variables produces:

$$\dot{q} = [ \begin{matrix}0 & I \\ - {\tilde{M}}^{- 1} \cdot \tilde{K} & 0\end{matrix} ] \cdot q + [ \begin{matrix}0 \\ {ϕ}^{T}\end{matrix} ] \cdot u = A \cdot q + B \cdot u and \\ y = [ ϕ 0 ] \cdot q = C \cdot q$$

This can be understood as the mathematical basis of the approach described here.

The modal analysis and model order reduction are performed for all components of the respective technical structure, i.e. here for all components of the HV motor. In this case, respective eigenshapes are used for the bidirectional connection of an inner modal description and an external Cartesian description. Like the respective eigenfrequencies, these are likewise an integral part of the modal analysis and hence do not entail any further computational effort. Here, the conversion of Cartesian and modal coordinates (modes) only takes place at the observation points so that, therefore, ultimately only an external effect of the respective component or the respective technical structure or system is computed. The computation takes place via the eigenshape matrix ϕ. The modes map k states of the respective system which are summarized in the state vector q(t). If present, these can be rigid-body modes, bending modes, torsion modes and/or the like.

Here, system excitation, corresponding to the input vector u(t), is broken down into excitations of the k states q(t) via

uᵢ(t)=Σ_{i,k}θ_{i,k}·qₖ(t),

wherein the index i stands for the respective excitation (input, location and degree of freedom) and θ_{i,k} indicates the associated element of the eigenshape matrix ϕ as the weighting element of the respective state. A response yⱼ(t) of each defined output j—for all outputs j summarized in the output vector y—is composed of the states q(t) and the eigenshape weighting factors θ_{j,k} as:

yⱼ(t)=Σ_{j,k}θ_{j,k}·qₖ(t).

In this way, the output yⱼ(t) can be computed for each defined observation point 27 and degree of freedom. The state space representation is fully described via the A, B and C matrices. In this way, an order-reduced model can be created overall.

The approach described here, including the change from Cartesian coordinates to modal coordinates and the limitation to prespecified observation points 27 enables significant model order reduction and thus opens up an enormous potential for accelerating computation and simulation.

In method step S6, the results of method step S5, i.e., for example, corresponding state space matrices are imported, preferably in a neutral format, into a system simulation, i.e. corresponding software or a corresponding program, for example “Ansys Twin Builder”. There, the order-reduced models of the individual components, i.e. so-called component twins, are assembled to form the digital representation of the entire technical structure. Thus, in this case, the component twins are connected to one another, wherein further elements can be added if necessary and the group of components can be inserted into its planned target application, i.e. a corresponding operational or working environment. For this purpose, for example, ambient, boundary and initial conditions can be defined and modeled. The further elements that can be added if necessary can, for example, represent bearing stiffnesses, air friction and/or the like. Ultimately almost any further elements can be inserted as long as they can be described mathematically. This can apply in particular to loads with different characteristics or couplings or the like. This approach can also be used to add further physical effects or domains. Finally, the result obtained here is the digital representation, i.e. an overall model or spectral image or likeness of the entire technical structure, possibly including its environment, which is also referred to here as a numerical twin.

In this regard, FIG. 4 shows a schematic representation illustrating such a digital representation in the form of a digital twin 17 of the HV motor including some ambient components, i.e. a numerical twin of a corresponding overall installation. Here, the main components of the HV motor are a housing 18, a cooling element 19 connected thereto, a stator 20, a rotor 21 and an active electric part 22. In this case, the stator 20 and the rotor 21 are, for example, mounted in the housing 18 and hence at least Indirectly mechanically coupled thereto. Further components connected to the HV motor can, for example, be an electrical power controller, here represented by an electrical power supply or a corresponding mains connection 23, a foundation 24, on which the housing 18 is to rest and be mounted, a coupling not shown in detail here, and a load 25, which is here connected schematically to the HV motor by a load machine 26.

Connections shown here between these components represent interactions or reciprocal actions or couplings between the components. These connections can, for example, be represented or modeled by using power, loads or effects that occur on one component as input variables for modeling or simulating another component connected thereto. The connections can likewise be represented by individual further elements. For this purpose, it is, for example, possible to insert ideal transmission elements, springs, dampers and/or the like into the digital twin 17. This ultimately allows the HV motor to be simulated in all modeled domains in its planned later operational environment, in particular in a particularly time-efficient manner and with improved accuracy compared to methods that are conventionally actually applied. Here, this is achieved by a combination of different measures and methods that has been found to be particularly effective. In particular, the modeling of the environment, represented here, for example, by the mains connection 23, the foundation 24 and the load machine 26, is a new property that represents a particular advantage of the digital twin 17 proposed here or the method presented here compared to conventional methods. This provides the possibility of modeling the environment together with any further components and respective couplings with their respective spectral behavior. Thus, it is possible to compute or simulate the behavior of the HV motor with its interaction with its environment, i.e. the overall behavior of the digital twin 17.

Here, a few observation points 27 at which the behavior or the external effect of the digital twin 17 in method step S8 is actually simulated are characterized by way of example. Therefore, here, the behavior of the digital twin 17 is, for example, computed, not at any arbitrary point of the housing 18 but, for example, only at its bearing points or connections to the other components of the digital twin 17 and correspondingly for the other components. A user of the digital twin 17 is typically mainly interested in certain items of core information relating to a respective user-specific application. This core information includes defined Interfaces and results at defined locations, for example the observation points 27. A particularly relevant interface of this kind is represented by the load machine 26. Here it is possible, for example, for values for speed and torque to be provided according to real requirements or measurements and computed or simulated using the digital twin 17. A further particularly relevant interface is a power terminal, here, for example, the mains connection 23 or the active electric parts 22. Here, in the case of the HV motor, for example, a three-phase alternating current from a mains supply with a defined voltage and frequency (DOL, direct online) or from an inverter supply with a regulated voltage and frequency for any speeds (VSD, variable speed drive) can be provided or simulated. A further interface, i.e. a further observation point 27, which can be particularly relevant for adaptation in the context of product development, is the foundation 24 or the connection thereof to the housing 18. In interaction with the structural components of the HV motor, this for example, defines a speed setting range.

These, and possibly, further interfaces are defined in the digital twin 17 in the form of the observation points 27. Others can be modeled subsequently if required. In the same way, monitor points can be or will be defined in addition to or as part of the observation points 27. Such monitor points can be placed at arbitrary locations of the digital twin 17 in order to pick up data or Information, i.e. to track behavior of the digital twin 17 in the context of the simulation. This is, in particular, also possible at points that are not readily accessible on a real counterpart. This technology can also be referred to as a virtual sensor or soft sensor since it entails virtual digital observation or analysis. Overall, this approach is particularly advantageous and offers particularly great potential for improvements to previous processes because, for example, it is possible to track positions of rotating and stationary parts in relation to one another without complex physical measuring methods.

In order to Improve the simulation of the digital twin 17 Iteratively, in method step S9, as long as or as soon as they are available, more detailed models, for example FE models, of further components, for example for the environment of the HV motor or for couplings between the components of the HV motor and/or for further physical effects can be integrated into the digital twin 17. In this case, if necessary, previously used, less detailed models can be replaced. Accordingly, therefore, some or all of method steps S6 to S10 can be run through Iteratively several times, thereby advantageously enabling improved efficiency, effectiveness and parallelism to be achieved in the development process.

In—the optional—method step S10, it is, for example, possible for a result of the simulation to be compared with a real counterpart that has been built of the digital twin 17 in order to enable an evaluation of the digital twin 17 or the method described here and/or in order, for example, to determine whether the real counterpart, i.e. a corresponding real installation, is operated within prespecified specifications. In this case, insights obtained can then, if necessary, be used to improve the method or the component twins, to improve production, to improve an operating strategy and/or the like.

Ultimately, In addition to familiar results, such as, for example speed-torque curves, the method presented here permits coherent modeling of the physics, i.e. more complete behavior of the digital twin 17 Including couplings between components, which, for example, makes it possible to determine bearing vibrations due to imbalance or, for example, loads on foundation bolts and/or the like, which was not possible with previous Individual component-specific considerations or individual models. This, for example, makes it possible to adapt parts, such as, for example, foundation bolts, better to actual loads and to obtain valuable information, such as, for example, force Introduction at different components, total force, for example on the foundation 24, vibration excitations by the HV motor for more extensive structural engineering analyses and the like.

The approach used can utilize a combination of two different types of modeling, namely causal modeling and physical modeling (conservative modeling). Causal modeling has defined input-output behavior. Physical modeling can, for example, use a node potential method (Kirchhoff rules) in order to establish a, bidirectional connection between two nodal points and hence between two components. In this sense, a node or nodal point can be a connection of an order-reduced model of a component to the environment or to another component or its order-reduced model. In particular simplified or idealized further elements, such as, for example springs, masses or damping elements can also be Integrated via physical modeling. This can advantageously enable intuitive applicability of the method described here for a wide range of specialist personnel, for example engineers from different disciplines.

A central process of the method presented here can be divided into two sections. These are, on the one hand, the generation of the component twins in the context of an FE analysis or FE modeling and, on the other, the simulative use of the overall twin, i.e. the complete digital twin 17, in the system simulation. For this purpose, it is currently possible to use the programs “Ansys Mechanicar” or “Ansys Twin Builder” for a practical application. This enables the process or the method to be at least substantially automated, for example by actuation via ACT (Application Compatibility Toolkit) or via IronPython (implementation of the Python programming language), i.e. by using the potential of modem programming.

In the context of process automation, in addition, the observation points 27 can, if necessary, be automatically set or generated, for example in dependence on the respective prespecified categories of the components. This can, for example, advantageously take place on the basis of the geometry data in the FE program. In this case, it is advantageously likewise possible for corresponding coordinate systems, degrees of freedom to be simulated, boundary and retaining conditions, adapted settings for the FE solver and/or the like to be defined or set automatically and the simulation or modeling to be started automatically.

According to a prespecified specification of the respective technical structure, if necessary, corresponding component twins can be retrieved from a corresponding model library that is provided, for example based on respective machine-readable product designations (MRPDs). In this case, the respective MRPD can indicate or specify the respective variant, configuration or embodiment of the component or the technical structure as a whole. For the HV motor, the MRPD can, for example, prespecify an axle height or a length digit of the active part 22 or the like. It is then possible to Import all required components or the models thereof provided automatically or semi-automatically into the respective simulation environment and for them to be connected to their adjacent components and/or to intermediate further elements, such as, for example, springs, dampers, transmission elements, etc.. It is also, for example, possible for the electro-mechanical energy conversion of the HV motor to be Inserted as a corresponding component twin and, for example, be automatically or semi-automatically provided with correct coefficients of a corresponding T-equivalent circuit diagram based on MRPDs.

Previously available software tools, enable, for example, the rotor dynamics of the HV motor to be computed individually in each case, a reliable speed setting range to be determined or a system response of the housing 18 to excitation, for example of an adjacent diesel engine or an earthquake or the like, to be ascertained from the structural dynamics. With previous methods, separate electrical simulation can be used to determine the behavior of the HV motor, wherein however, the mechanical basis used is a greatly simplified rotor model in the form of an idealized two-mass vibrator instead of the actually specified 3D geometry data of the rotor 21,

However, these conventional software tools fail if, for example, the structural dynamics influence rotor-dynamic effects, since a corresponding complete analysis would require Impracticable amounts of computing time and computer resources. Therefore, to date, Interactions between components have not been considered or at least not realistically. However, it is expected that interactions of this kind will be accorded greater significance in future, i.e. become more important, since, for example, simultaneous requirements with respect to material savings, enhanced performance, Improved efficiency and utilization for complex systems will lead to Increased inclusion of coupling effects among components.

The method proposed here enables the entire physics of even a complex technical structure to be modeled coherently in FE accuracy across domains at least for the ultimately relevant observation points 27 with a computational effort that is limited due to the measures for model order reduction, which enables a complete simulation run for the digital twin 17 with a time horizon of, for example, a few minutes instead of several days or weeks. In this case, despite the model order reduction, new insights can be obtained compared to previous methods since, in the present case, not only Individual components and domains are considered Individually in isolation, but for example combined eigenshapes of a plurality of components and/or from a plurality of domains can be considered as combined or Interacting with one another, i.e. simulated. Since the domains are modeled coherently, results can be generated from Interactions across corresponding domain boundaries.

Overall, the examples described here show how digital handling of a complex technical structure can be improved by the adapted generation of a numerical twin of the technical structure.

In summary, hence, the Invention relates to a computer-aided method 1 and a device C1 for generating a digital representation 17 of a technical structure, in particular an electric motor, and to a corresponding computer program product 1, C2. In the method 1, domain-specific models based on digital geometry data of components 2,18,19,20,21,22 are provided. On the basis thereof, model order reduction is performed, wherein the domain-specific models are converted into modal coordinates and used to determine the spectral behavior of the components 2,18,19,20,21,22 by means of a respective modal analysis. On the basis thereof, corresponding state space representations are generated as order-reduced spectral models. In order to simulate the technical structure as a whole, the spectral models are coupled to one another to form the digital representation 17 describing the behavior of the technical structure across domains for a simulation.

1-14. (canceled)

15. A computer-aided method for generating a digital representation in form of a digital model of a prespecified technical structure, comprising:
providing domain-specific models of prespecified components of the electric motor based on digital 3D geometry data of the prespecified components,
performing a model order reduction based on the domain-specific models by
converting the domain-specific models into modal coordinates,
determining a spectral behavior of the prespecified components by a respective modal analysis, and
generating based on the spectral behavior state space representations for the prespecified components as order-reduced spectral models, and
coupling, for a simulation of the technical structure as a whole, the spectral models of the prespecified components with one another to form the digital representation which describes the behavior of the technical structure across a plurality of domains.

16. The method of claim 15, wherein the prespecified technical structure is an electric motor.

17. The method of claim 15, further comprising using the simulation for generating a digital representation as a digital model or a digital twin of the prespecified technical structure.

18. The method of claim 15, wherein the prespecified technical structure is an electric motor, and the prespecified components are selected from at least one of a housing, a rotor, a stator, a cooling facility and an active electric part of the electric motor.

19. The method of claim 15, wherein the domain-specific models each model or describe properties or behavior of a respective prescribed component in a physical-technical domain.

20. The method of claim 15, wherein the domain-specific models relate to at least one of mechanics, electrics, electrodynamics, thermal properties and thermodynamics, wherein the domain-specific models have a reduced complexity in comparison to a complete model, making it possible to generate and handle the domain-specific models with less effort.

21. The method of claim 15, further comprising
determining in the respective modal analysis for the components a modally decoupled mass matrix M and stiffness matrix K,
based on the equation of motion for the respective prescribed component, arranging the modally decoupled mass matrix M and the stiffness matrix K via state space representation so as to yield the following results for one degree of freedom:
$$\dot{q} = [ \begin{matrix}0 & I \\ - {\tilde{M}}^{- 1} \cdot \tilde{K} & - {\tilde{M}}^{- 1} \cdot \tilde{D}\end{matrix} ] \cdot q + [ \begin{matrix}0 \\ {ϕ}^{T}\end{matrix} ] \cdot u ; \\ y = [ ϕ 0 ] \cdot q$$
wherein
$$q = ( \begin{matrix}S \\ \dot{S}\end{matrix} )$$
is a time-dependent state vector, s is a time-dependent position vector, \tilde{M}⁻¹·\tilde{K} is a diagonal matrix of eigenvalues, I is the unit matrix, D is a damping matrix, ϕ is an eigenshape matrix, u is a time-dependent input vector, and y is a time-dependent output vector.

22. The method of claim 15, wherein the respective modal analysis is only performed for a prespecified lower frequency range.

23. The method of claim 22, wherein the prespecifled lower frequency range is between 0 Hz and 2 kHz.

24. The method of claim 22, wherein the respective modal analysis is only performed for a prespecified number of the highest-energy modes.

25. The method of claim 15, further comprising
performing, after the modal analysis, a conversion of the original coordinates of the domain-specific models into modal coordinates or a conversion of the modal coordinates back into other coordinates, in particular into the original coordinates, for the model order reduction, for a prespecified selection of discrete observation points at which an external effect of the technical structure as a whole is determined during the simulation.

26. The method of claim 25, wherein a number of discrete observation points is at most 1000.

27. The method of claim 25, further comprising automatically establishing the discrete observation points in the digital 3D geometry data for the components in dependence on a prespecified category of the respective component.

28. The method of claim 15, further comprising
when generating the digital representation of the technical structure, employing Idealized coupling elements for connecting at least some of the spectral models of the components to one another or to prespecified further elements of idealized coupling members, or both.

29. The method of claim 15, further comprising
connecting at least one of the spectral models of the components to at least one prespecified digitized ambient component which represents an environment of the technical structure in a planned real application, and
generating a digital representation of an installation for the simulation which includes the technical structure.

30. The method of claim 29, further comprising
initially representing the at least one ambient component by at least one idealized element, and
replacing the at least one idealized element in an iterative Improvement process of the digital representation by a finite element model or by an order-reduced spectral model of the at least one ambient component derived from the at least one idealized element.

31. A computer program product embodied on a computer-readable non-transitory medium and comprising computer commands which, when read into a memory of the computer and executed by a processor of the computer, cause the processor to automatically execute the method of claim 15.

32. A data processing device configured to automatically to execute the computer commands of the computer program product of claim 31.
